(19) United States
(12) Patent Application Publication
(10) Pub. No.: US 2026/0326653 A1
(43) Pub. Date: Oct. 22, 2026

(54) APPARATUS FOR TRANSPORTING LIQUID MATERIALS AND METHOD FOR REDUCING FREE SPACE WITHIN THE SAME

(71) Applicant: Bulk Cargo Systems, LLC, Charleston, SC (US)

(72) Inventor: David BUONERBA, Charleston, SC (US)

(21) Appl. No.: 19/468,187

(22) Filed: Feb. 3, 2026

Related U.S. Application Data
(63) Continuation-in-part of application No. 18/946,451, filed on Nov. 13, 2024.
Application No. 18/946,451 is a continuation of application No. 18/901,281, filed on Sep. 30, 2024, now Pat. No. 12,337,745.

(51) Int. Cl. B60P 3/42; B60P 3/22; B60P 3/24; B65D 90/52

(52) U.S. Cl. CPC B60P 3/426; B60P 3/2215; B60P 3/226; B60P 3/243; B65D 90/52

(57) ABSTRACT

An apparatus and method for selectively transporting solid freight or bulk liquid freight. The apparatus includes longitudinal first and second side frames secured to a shipping container, and front and rear frames that are removably affixed and adjustable along the side frames to define an internal area. A collapsible liquid container is positioned within the frame and includes an outer liner, an internal bladder, and a fluid conduit. A reel mounted to longitudinal rails and attached to the rear of the container to wrap and collapse the container for emptying, storage, or removal. One or more baffles are positioned between the side frames and on top of the container to pin the container within the frame. The method includes positioning the liquid container in the frame, adjusting traverse members to set the internal area, filling the container, and installing baffles to form fluidly connected sections thereby reducing free space.

### CROSS-REFERENCE TO RELATED APPLICATIONS

This application is a continuation-in-part of and claims priority pursuant to 35 U.S.C. 120 to U.S. application Ser. No. 18/946,451, filed Nov. 13, 2024, which application claims priority to U.S. application Ser. No. 18/901,281, filed Sep. 30, 2024, now U.S. Pat. No. 12,337,745, issued on Jun. 24, 2025, which applications and patent are incorporated herein by reference in their entireties.

### FIELD

This disclosure relates generally to a method and apparatus for transporting liquid materials, particularly bulk liquid, by vehicle and more particularly to a method and apparatus for transporting such materials in a shipping container that can also be used for transporting conventional dry materials or other non-liquid cargo. More specifically, this disclosure relates to collapsible tanks for freight containers, or shipping containers, that allow the container arranged on a transport vehicle, such as a truck trailer, ocean borne container, railroad car or container, or the like, to be converted to selectively carry solid freight or bulk liquid freight. Additionally, the disclosure also relates to a method of reducing free space in a liquid container.

### BACKGROUND

Collapsible tank systems are often used for transporting bulk liquids in shipping containers, allowing for flexible use of transport assets. However, these systems face significant challenges related to vehicle stability, operational efficiency, and cargo flexibility.

A primary safety concern in liquid transport is the dynamic force generated by liquid “sloshing” within a partially filled container, which can lead to vehicle instability. This issue is particularly pronounced in systems that use fixed-size containers. The amount of liquid in any given load rarely matches the container's full capacity, especially when transporting high-density liquids where legal highway weight limits are reached before the tank is volumetrically full. This unavoidable free space promotes dangerous liquid surge during acceleration and braking.

Furthermore, systems employing reusable liners, while common, introduce considerable operational and financial burdens. These liners require costly, time-consuming, and resource-intensive cleaning between uses, often at specialized wash facilities. This cleaning requirement has historically dictated tank designs, necessitating large man-ports to allow for human entry for inspection and cleaning. This, in turn, mandates taller containers with a higher, less stable center of gravity. The weight of these heavier tank systems also reduces the maximum payload of liquid product that can be legally transported.

While some prior solutions have provided improvements, they have introduced their own challenges. For instance, some flexible frame systems can be mechanically complex, making the assembly and conversion process between wet and dry transport modes difficult and labor-intensive, especially for a single operator, like the one described in U.S. Pat. No. 11,643,003, issued May 9, 2023, which patent is incorporated by reference herein in its entirety.

Another persistent inefficiency in existing designs is the incomplete evacuation of product from the container. Simple gravity-fed outlets often leave a significant residual “heel” of liquid trapped inside, leading to wasted product and reduced overall transport yield.

Therefore, there remains a clear need for an improved liquid transport apparatus that can safely and efficiently adapt to various cargo volumes and densities, while minimizing free space to enhance safety. A need also exists for a system that simplifies single-operator handling during both the conversion process and the product emptying phase, while also maximizing product evacuation to reduce waste.

### SUMMARY

Described herein are various embodiments of an apparatus and method for selectively transporting solid freight or bulk liquid freight within a shipping container. The apparatus could include a frame to house a collapsible liquid container, and a series of baffles positioned on top of the container to dampen liquid movement. An important aspect of the apparatus is an adjustable frame with one or more repositionable end members. This allows an operator to reduce the longitudinal length of the containment area, ensuring that liquid cargoes of varying densities and volumes can be transported safely by minimizing free space and sloshing. To further reduce free space, a conduit in fluid communication with the liquid container, has an integrated air release mechanism or air bleeder, allowing excess or entrapped air within the liquid container to be removed. To improve operational efficiency, the apparatus also includes a reel system. This reel provides a controlled method for a single operator to collapse the empty container for storage and creates a gravity-assist to ensure a more complete evacuation of the liquid product, thereby reducing “heel”, leftover product, which is discarded.

Generally, the present disclosure describes an apparatus and method for selectively transporting solid freight or bulk liquid freight. The apparatus includes longitudinal first and second side frames secured to a shipping container, and front and rear frames that are removably affixed and adjustable along the side frames to define an internal area. A collapsible liquid container is positioned within the frame and includes an outer liner, an internal bladder, and a fluid conduit. A reel mounted to longitudinal rails and attached to the rear of the container to wrap and collapse the container for emptying, storage, or removal. One or more baffles are positioned between the side frames and on top of the container to pin the container within the frame. The method includes positioning the liquid container in the frame, adjusting traverse members to set the internal area, filling the container, and installing baffles to form fluidly connected sections thereby reducing free space.

According to aspects illustrated herein, there is provided an apparatus for use in a shipping container for selectively carrying solid freight and bulk liquid freight, comprising: a first side frame and a second side frame that both extend longitudinally with respect to the shipping container and are fixedly secured thereto; a front frame removably affixed to and adjustably positioned between the first and second side frames along respective lengths of the side frames; a rear frame removably affixed to and adjustably positioned between the first and second side frames along respective lengths of the side frames opposite the front frame; a collapsible liquid container having a front end and a rear end, the container further comprising: a liquid impermeable outer liner; a liquid impermeable inner bladder arranged within the outer liner; and, a fluid conduit positioned proximate the front end and in fluid communication with the inner bladder; a reel configured to be rotatably and translatably connected to a pair of rails that extend longitudinally with respect to the shipping container, the reel having at least one tether extending therefrom and connected to the collapsible liquid container proximate the rear end thereof, thereby wrapping the collapsible liquid container around the reel upon rotation of the reel; and, at least one baffle operatively arranged to be positioned between the first and second side frames and on top of the collapsible liquid container, wherein the collapsible liquid container is adapted to be removably pinned at least partially within the frame via the at least one baffle.

In any of the aforementioned aspects, the apparatus may also have one or more of: the fluid conduit comprising: a longitudinal tube portion having a first end and a second end, the first end arranged within the inner bladder and the second end extending through the inner bladder and affixed thereto; a connection elbow extending from the first end; and/or, a valve affixed to the front frame and arranged to removably secured to the connection elbow, where the valve further comprises a flow meter; each rail of the pair of rails comprises a channel, each of the channels configured to accept respective ends of the reel therein; or, the reel comprises at least one handle extending therefrom.

In any of the aforementioned aspects, the first side frame has a first plurality of apertures disposed therein; the second side frame has a second plurality of apertures disposed therein; the front frame has a pair of apertures disposed therein; the rear frame has a pair of apertures disposed therein; one aperture of the pair of apertures of the front frame and one aperture of the first plurality of apertures configured to be substantially aligned and accept a first pin therein to secure the front frame to the first side frame; the other aperture of the pair of apertures of the front frame and one aperture of second plurality of apertures configured to be substantially aligned and accept a second pin therein to secure the front frame to the second side frame; one aperture of the pair of apertures of the rear frame and another aperture of the first plurality of apertures configured to be substantially aligned and accept a third pin therein to secure the rear frame to the first side frame; the other aperture of the pair of apertures of the rear frame and another aperture of second plurality of apertures configured to be substantially aligned and accept a fourth pin therein to secure the rear frame to the second side frame.

According to further aspects, there is provided an apparatus for use in an elongated shipping container, e.g., a shipping container on a trailer, for selectively carrying solid freight and bulk liquid freight comprising a frame fixedly secured to and within the shipping container, the frame comprising at least: two side members and at least one end member connected to the side members, a collapsible liquid container removably connected to the frame, the container having a liquid impermeable outer liner and a liquid impermeable inner bladder arranged within the outer liner, a fluid conduit in fluid communication with the inner bladder and removably connected to the frame, and at least one baffle operatively arranged to be removably secured at least partially within the frame and on top of the collapsible liquid container.

In some embodiments, any of the aforementioned apparatuses may further comprise a second baffle (i.e., a first and second baffle) operatively arranged to removably secure to the frame and on top of the collapsible liquid container, whereas the at least one baffle (i.e. the first baffle) and the second baffle are spaced apart. Alternatively, the aforementioned apparatus may further comprise a third and fourth baffle, where each of the first, second, third, and fourth baffle may have at least one concave face thereon.

In one aspect, the present disclosure may comprise an apparatus for use in a shipping container for selectively carrying solid freight and bulk liquid freight, the apparatus including a first side frame extending longitudinally with respect to the shipping container and fixedly secured thereto, a second side frame extending longitudinally with respect to the shipping and fixedly secured thereto, a front frame positioned between the first and second side frames, a collapsible liquid container operatively arranged substantially between the first and second side frames, the liquid container further comprising: a liquid impermeable outer liner; a liquid impermeable inner bladder arranged within the outer liner; and, a fluid conduit in fluid communication with the inner bladder, a rear fame removably affixed to the first and second side frames opposite the front frame, and at least one baffle operatively arranged to be positioned between the first and second side frames and on top of the collapsible liquid container, wherein the collapsible liquid container is adapted to be removably pinned at least partially within the frame via the at least one baffle.

In some configurations, the aforementioned apparatus the at least one baffle comprises a first baffle operatively arranged to be positioned between the first and second side frames and on top of the collapsible liquid container, and a second baffle operatively arranged to be positioned between the first and second side frames and on top of the collapsible liquid container and spaced apart from the first baffle.

In one possible embodiment, any aforementioned first and second baffles may comprise: a top face and a bottom face bounded by a pair of side faces; a pair of concave faces disposed between the top and bottom faces; and, a channel arranged within the pair of concave faces and the bottom face.

In some embodiments, each of the first and second baffles may also comprise a channel disposed within the top and the pair of side faces, the channel operatively arranged to accept a support member therein.

In a further possible configuration, any of the aforementioned apparatus may further comprise a front end baffle arranged at least partially within the side frames and proximate the front frame, the front end baffle having: a top face and bottom face bounded by a pair of side faces; a concave face disposed between the top and bottom faces and facing the rear frame; and, a rear face disposed between the top and bottom faces and facing the front frame.

In another configuration, any of the aforementioned apparatuses may further comprise a rear end baffle arranged at least partially within the side frames and proximate the rear frame, the rear end baffle having: a top face and bottom face bounded by a pair of side faces; a concave face disposed between the top and bottom faces and facing the rear frame; a rear face disposed between the top and bottom faces and facing the rear frame; and, a conduit channel disposed within the top, bottom, and concave face, wherein the conduit channel is adapted to accept at least a portion of the fluid conduit at least partially therein.

In some embodiments, any of the aforementioned apparatuses may further comprise at least one retaining cover adapted to at least partially cover a space disposed between the side frames, the at one retaining cover retractably secured to a top surface one of the side frames and removably secured to a top surface of the opposite side frame, the at least one retaining cover further adapted to pin the at least one baffle down and onto the liquid container.

In some embodiments, any of the aforementioned apparatuses may further comprise a longitudinal tube portion having a first end and a second end, the first end arranged within the inner bladder and the second end extending through the inner bladder and affixed thereto, and a connection elbow extending from the first end.

In other configurations, any of the aforementioned fluid conduits may further comprises a petcock valve affixed to the front frame and designed to be removably secured to the connection elbow, the petcock valve having an integrated air release mechanism. where the petcock valve may further comprises a flow meter configured to measure and display the volume and/or flow rate of a liquid passing through a fluid passageway of the valve.

In some embodiments, any of the aforementioned apparatus may further comprise a sliding plate connected to the rear frame and adapted to move vertically, the valve affixed to the sliding plate.

In other configurations, the at least one baffle is configured to absorb energy from liquid disposed in the collapsible liquid container

In further embodiments, the baffles are comprised of one or more of an open cell foam or a closed cell foam.

In further possible configurations, the rear end baffle is comprised of one or more of an open cell foam or a closed cell foam.

In even further possible configurations, the front end baffle is comprised of one or more of an open cell foam or a closed cell foam.

According to aspects illustrated herein, there is also provided a method for reducing free space in a liquid container within a shipping container, where the method comprises the steps of: placing the liquid container into a frame with the shipping container; selecting a longitudinal position for one or more traverse members of the frame to establish an internal area within the frame; filling the liquid container with one or more of a liquid or liquid slurry; securing one or more baffles on top of the filled liquid container and at least partially within the frame to create two or more fluidly connected sections within the filled liquid container.

In a further aspect, the aforementioned method also includes a further step of removing excess air from the filled liquid container, preferably via a petcock valve having integrated air release mechanism, which valve is in fluid communication with both of the liquid container and the filled liquid container.

In one possible aspect, the aforementioned method also includes a further step of securing one or more retaining covers over one or more of the filled liquid container or the one or more baffles.

In a further aspect, the disclosure provides an apparatus for use in a shipping container for selectively carrying solid freight and bulk liquid freight. The apparatus comprises a frame adapted to be secured within the shipping container, a collapsible liquid container positioned within the frame, a pair of rails adapted to be secured longitudinally within the shipping container, and a reel rotatably and translatably mounted on the pair of rails. The reel is operatively arranged to wind the collapsible liquid container thereon to collapse the container.

In some embodiments of the aforementioned apparatus, the reel may comprise at least one handle extending therefrom. The handle is configured to receive a rotational force from an operator to wind the collapsible liquid container.

In another possible configuration, the apparatus may further comprise a tether connecting the reel to the collapsible liquid container. In this configuration, rotation of the reel winds the tether, which in turn pulls the collapsible liquid container toward the reel to facilitate its collapse and assist in emptying residual product.

In a further embodiment, the frame of the apparatus may be an adjustable frame. The adjustable frame may comprise a first side frame and a second side frame, where each of the side frames has a plurality of apertures disposed therein. The adjustable frame further comprises at least one end frame that is removably positionable between the first and second side frames at a selected longitudinal position by inserting one or more pins through corresponding apertures in the at least one end frame and the plurality of apertures of the side frames.

In another aspect, the disclosure provides a baffle for dampening liquid movement within a liquid transport container, the baffle comprising: a top face having a first length and a bottom face having a second length; and a pair of oppositely facing concave faces disposed between the top face and the bottom face, wherein the first length is greater than the second length, thereby creating an overhang configured to redirect liquid downward.

The baffle of the preceding aspect may further comprise a channel disposed within the top face, and a support beam positioned within the channel, the support beam configured to extend between side frames of a transport apparatus to provide structural support.

In yet another aspect, the disclosure provides a retention system for securing a baffle onto a collapsible liquid container within a frame having a first side frame and a second side frame, the retention system comprising: a flexible retaining cover adapted to be positioned over the baffle; at least one adjustable connector secured to the first side frame, the adjustable connector comprising a housing, a rotatable spool, and a tether configured to connect to the retaining cover; and at least one hook secured to the second side frame and configured to engage a portion of the retaining cover, wherein rotation of the spool adjusts the tension of the retaining cover over the baffle.

In the retention system of the preceding aspect, the spool of the at least one adjustable connector may further comprise a ratchet mechanism configured to prevent the spool from rotating in a direction that would release tension from the tether until the ratchet mechanism is disengaged.

Generally, the first, second, third, and fourth baffles (300, 302, 700, 800) of the aforementioned apparatus (100) are generally configured to absorb energy from liquid disposed in the collapsible liquid container (200), thereby dampening a liquid sloshing effect from the liquid disposed in the collapsible liquid container (200) produced when the shipping container (2) is in motion. Further, the first, second, third, and fourth baffles (300, 302, 700, 800) of the aforementioned apparatus (100) each include at least one concave face, which concave faces are designed to redirect liquid or fluid within the liquid container in one or more of a direction away from the concave face or downwardly.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a shipping container, partly in phantom, showing a frame having a fluid container therein in accordance with one aspect of this disclosure configured for transporting liquid cargo;

FIG. 2A is a rear view of the invention shown in FIG. 1;

FIG. 2B is a rear view of the invention shown in FIG. 2A with retaining covers removably attached to the frame;

FIG. 2C is a rear view of the invention shown in FIG. 2A with the baffles removed and an empty fluid container removably connected to a retraction line attached to a wall of the shipping container;

FIG. 3A is a skeleton perspective view of a baffle of the invention shown in FIG. 1;

FIGS. 3B through 3D are a perspective views of end baffles of the invention shown in FIG. 1;

FIG. 4 is a partial perspective view of the invention in FIG. 2B, specifically showing the retaining cover and its respective attachment mechanisms;

FIG. 5A is a cross-sectional view of the frame and fluid container taken generally along line 5-5 in FIG. 1;

FIG. 5B is an enlarged portion taken from FIG. 5A generally illustrating a fluid conduit;

FIG. 5C is an enlarged portion taken from FIG. 5A generally illustrating one of the middle baffles and its respective passageway;

FIGS. 6A and 6B are cross-sectional views from FIG. 5A generally showing fluid movement within the fluid container;

FIG. 7 is a perspective view of a shipping container, partly in phantom, showing a frame having a fluid container therein in accordance with another aspect of this disclosure configured for transporting liquid cargo;

FIG. 8 is a perspective view illustrating the liquid container in FIG. 7 being emptied (or deployed) and a traverse member of the frame in an alternative position;

FIG. 9 is a rear view of the shipping container, frame, and liquid container shown in FIGS. 7 and 8;

FIG. 10 is the cross-sectional view taken generally long LD1 or LD2 in FIG. 9;

FIGS. 11A and 11B illustrate a preferred embodiment of a petcock valve of the fluid conduit of the frame, and liquid container shown in FIGS. 7-10; and,

FIG. 12 generally illustrates a method for reducing free space in a liquid container within a shipping container.

### DETAILED DESCRIPTION

At the outset, it should be appreciated that like drawing numbers on different drawing views identify identical, or functionally similar, structural elements. It is to be understood that the claims are not limited to the disclosed aspects, and that the disclosure is not limited to the particular methodology, materials, and modifications described, and as such may, of course, vary. It is also understood that the terminology used herein is for the purpose of describing particular aspects only, and is not intended to limit the scope of the claims. Unless defined otherwise, all technical and scientific terms used herein have the same meaning as commonly understood by one of ordinary skill in the art to which this disclosure pertains.

The term “exemplary” is used herein to mean serving as an example, instance, or illustration. Any embodiment or design described herein as “exemplary” is not necessarily to be construed as preferred or advantageous over other embodiments or designs. As used in the specification and the appended claims, the singular forms “a,” “an,” and “the” include plural referents unless the context clearly dictates otherwise. The words “may,” “can,” “could,” and “should” are used permissively, not mandatorily, and are intended to mean “having the potential to,” unless the context clearly indicates otherwise.

As used herein, the word “or” is intended to be used in its inclusive sense (and not in its exclusive sense), so that when used in a list of two or more items, the word “or” means any one of the listed items or any combination of the listed items. Likewise, the term “and/or” is intended to mean a grammatical conjunction used to indicate that one or more of the elements or conditions recited may be included or occur.

The term “substantially” is intended to mean that the recited characteristic, parameter, or value need not be achieved exactly, but that deviations or variations, including for example, tolerances in manufacturing, measurement, and system operation, do not materially affect the basic and novel characteristics of the disclosure. The term “approximately” is intended to mean that the recited value is not exact but is within a certain range of the specified value, for example, within ten percent of the specified value.

The transitional phrase “comprising,” which is synonymous with “including,” “containing,” or “characterized by,” is inclusive or open-ended and does not exclude additional, unrecited elements or method steps. The present disclosure also expressly contemplates embodiments that “consist of” or “consist essentially of” the recited elements. The phrase “consisting of” excludes any element, step, or ingredient not specified in the claim. The phrase “consisting essentially of” limits the scope of a claim to the specified materials or steps and those that do not materially affect the basic and novel characteristic(s) of the claimed subject matter.

Where specific dimensions, lengths, or other quantitative values are provided, such as lengths “L1” through “L8” or height “H”, they are presented for purposes of illustration and are not intended to be limiting. The disclosure contemplates any other suitable dimensions, whether in imperial, metric, or other units, as would be appropriate for the intended application and manufacturing capabilities. The principles described herein can be scaled to fit shipping containers and transport vehicles of various standard and non-standard sizes.

The materials described herein, such as high-density foam, Kevlar® fabric, and specific thermoplastics like polyethylene or PVDF, are intended to be exemplary. The structural components of the frame and reel may be formed from any suitable material possessing the required strength and durability, including but not limited to various metals such as steel or aluminum, metal alloys, composites like carbon fiber, or even treated wood. The liners and baffles may be formed from any suitable polymeric, elastomeric, or composite material that provides the desired impermeability and energy-absorption characteristics. The manufacturing of these components may be accomplished by any suitable process, including but not limited to welding, casting, injection molding, thermoforming, film extrusion, CNC machining, or 3D printing, as would be understood by a person skilled in the art. Those in the art will understand that any suitable material, now known or hereafter developed, may be used in forming the disclosed embodiments and aspects described herein.

As used herein, the term “fluid communication” is intended to mean that a path or connection exists between two or more components that allows a fluid (e.g., a liquid, gas, or slurry) to flow or be transferred between them, either directly or indirectly. This connection may be permanent, temporary, or selectively opened and closed by a component such as a valve.

The primary use case described herein is the transport of bulk liquid freight, such as food-grade products or chemicals, within standard shipping containers like truck trailers, ocean containers, or railroad cars. This is intended to be exemplary and not limiting. The apparatus and methods disclosed could be adapted for a wide range of other applications, including but not limited to the transport or temporary on-site storage of agricultural liquids such as fertilizers or pesticides, industrial slurries, non-potable water for construction or emergency services, or any other bulk fluid material where controlled transport and handling are desired.

The disclosure contemplates that certain functions, such as the operation of the reel or the monitoring of the flow meter, may be enhanced with electronic components. For instance, the reel may be operated by a motorized system controlled by a processor. Such a system could include sensors to monitor tension or container position. The flow meter may include a processor and a wireless transmitter to send volume and flow rate data to a user's mobile device or a central dispatch system. Any electronic components may be powered by the transport vehicle's electrical system, a dedicated rechargeable battery, or other suitable power sources as would be known in the art.

Broadly, embodiments of the present disclosure comprise a frame and the frame being either a substantially fixed frame or a frame having at least one adjustable end frame member, the frame having a collapsible liquid container comprising an outer liner and an inner bladder, the inner bladder arranged to receive a fluid therein, where both the outer liner and inner bladder are liquid impermeable, at least one baffle, and a fluid conduit in fluid communication with the inner bladder. It should be appreciated that a preferable aspect of the present disclosure may include one or more of: a pair of baffles; a pair of medial/inner baffles and a pair of respective end baffles; a securement mechanism, such as at least one retaining cover, for the at least one bladder; at least one removable end frame member; a fluid conduit having a valve and a inlet/outlet tube in communication with the inner blade, where the valve is arranged to removably secure to the inlet/outlet tube, and the valve includes an integrated air release mechanism; means to removably secure the collapsible liquid container to the frame; and, a means to expand or collapse the collapsible liquid container.

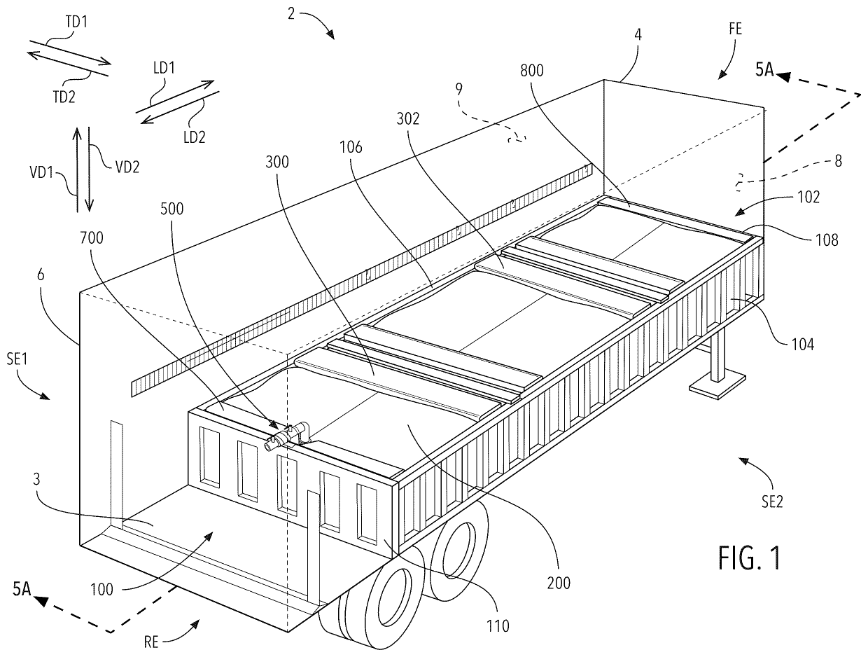

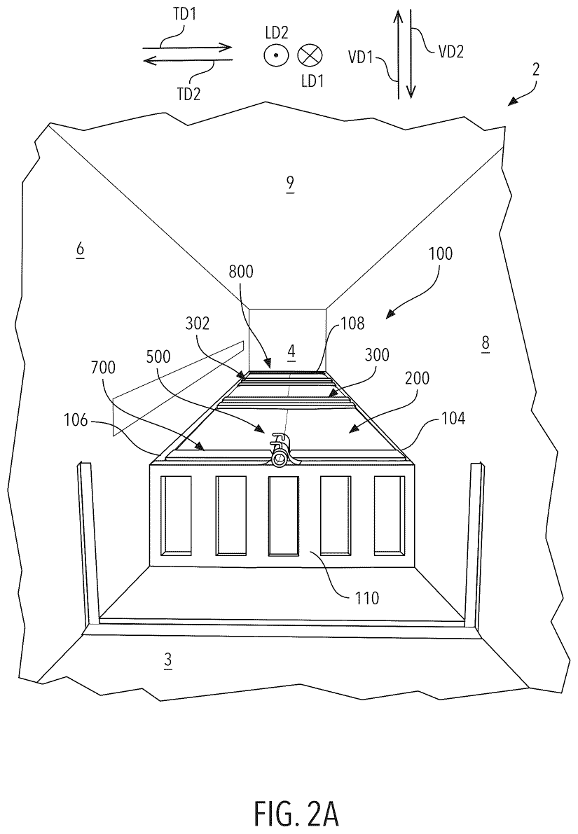

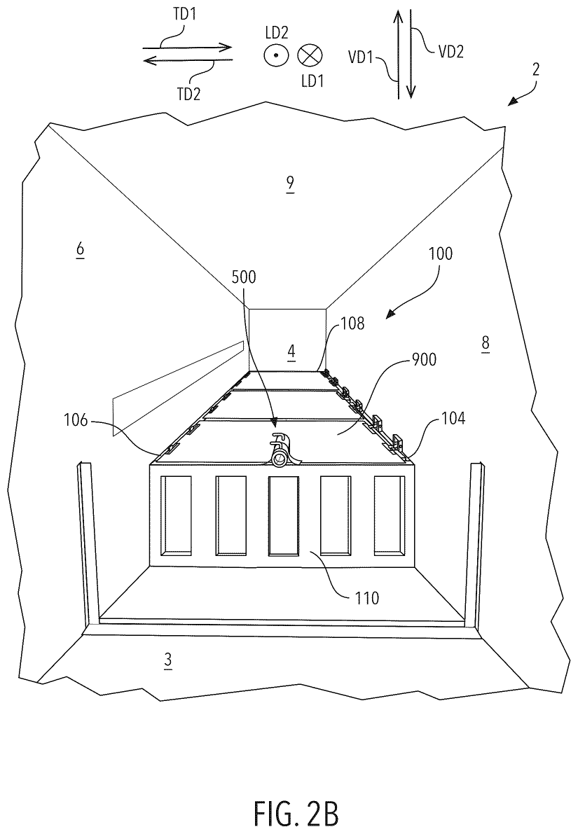

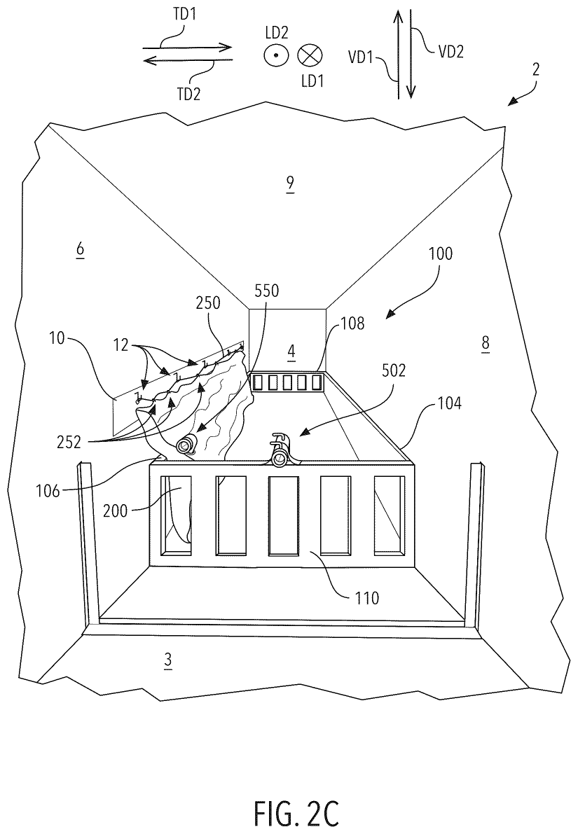

Adverting now to the figures, an exemplary embodiment of a present apparatus for transporting liquid is illustrated in FIGS. 1 through 2B, specifically FIG. 1 generally shows a perspective view of the apparatus arranged within an embodiment of a shipping container, particularly a shipping container arranged to be transported by a tractor trailer. FIGS. 2A and 2B generally show a rear view of the same, where FIG. 2B illustrates retaining covers arranged on a frame of the apparatus.

Liquid transporting tank apparatus 100 (hereinafter “apparatus”), in accordance with an aspect of the present disclosure, is illustrated as it could be installed in shipping container 2 of a tractor-trailer truck (not shown). “Shipping container” is intended to mean a “freight container,” “cargo container,” “intermodal container,” “iso container,” “sea container” or “ocean container,” “sea can” or “c-can,” “container van” or “dry van,” “insulated container,” “double door container,” “swap body container,” “road semi-trailer” or highway semi-trailer,” and the like, and such terms are intended to be interchangeable. Collapsible liquid container 200 (hereinafter “container”) is removably contained within frame 102, whereas frame 102 comprises a plurality of interconnected frame-members disposed within the shipping container, preferably spanning at least a substantial portion between front wall 4 and rear wall 3 and also spanning between sidewalls 6 and 8. In some embodiments, container 200 is contained within first and second sidewalls 104 and 106, respectively, and front and rear end walls 108 and 110, respectively, that together form a generally rectangular enclosure, i.e., frame 102. Preferably, sidewalls 104 and 106 are fixedly attached to the shipping container body, i.e., at least one of sidewalls 6 and 8 and floor 3, thereby affording a maximum distance therebetween in transverse directions TD1 and TD2, i.e., a distance between sidewalls 6 and 8. It could be said that frame 102 may be comprised of sidewalls 104 and 106, end walls 108 and 110, and floor 3, such that frame 102 is generally a rectangular enclosure having a bottom or a floor. It should be appreciated that frame 102 could separately include a floor member being connected to one or more of sidewalls 104 and 106 and end walls 108 and 110. Preferably, at least sidewalls 104 and 106 are fixedly secured to the shipping container body, e.g., one or more of wall 6, wall 8, or floor 3.

In other possible configurations, front end wall 108 may be formed from front wall 4 of shipping container 2 or a separate front wall panel or member may be used. When front end wall 108 is formed by front wall 4 of shipping container 2, side walls 104 and 106 should be positioned that the front ends of side walls 104 and 106 (i.e., the ends proximate front end FE) are close to or in contact with front wall 4 of shipping container 2. As shown in FIG. 1 and in a preferred configuration, the rear ends of side walls 104 and 106 (i.e., the ends proximate rear end RE) do not extend to the terminating end of the shipping container body proximate rear end RE, thus, providing an area on floor 3 where a user may stand within the shipping container body and access apparatus 100. In some configurations, rear end wall 110 may be removable or may be comprised of a gate-like configuration such that the aforementioned space proximate rear end RE is needed for opening and closing thereof (similar to the configurations described in U.S. Pat. No. 11,643,003).

In one contemplated aspect, container 200 includes fluid conduit 500 in fluid communication therewith. Fluid conduit 500 is attached to container 200 and rear wall 110, preferably on a top surface or end thereof, such that fluid conduit 500 is raised above floor 3 of the shipping container body. Fluid conduit 500 is arranged for filling and emptying of container 200 and is detailed further, infra.

In some embodiments, container 200 is divided into two or more sections, e.g., three sections, by baffles 300 and 302 that are positioned transversely in container 200, as shown in FIG. 1. Baffles 300 and 302 extend substantially from the top of frame 102, i.e., first and second sidewalls 104 and 106, respectively, and front and rear end walls 108 and 110, respectively, downwardly towards base or floor 3 of shipping container 2. Baffles 300 and 302 may extend beyond respective top surfaces of sidewalls 104 and 106, i.e., a greater distance in vertical direction VD1. In a preferred embodiment, container 200 further includes end baffles, rear end baffle 700 and front end baffle 800, where front end baffle 800 is arranged between sidewalls 104 and 106 and proximate front end wall 108, and where rear end baffle 700 is arranged between sidewalls 104 and 106 and proximate rear end wall 110. Thus, one section of container 200 is formed between rear end baffle 700 and baffle 300, a second section of container 200 is formed between baffles 300 and 302, and a third section of container 200 is formed between baffle 302 and front end baffle 800. Baffles 300, 302, 700, and 800 are discussed further, infra.

In reference to FIG. 2B, the aforementioned baffles (e.g., baffles 300, 302, 700, and 800 in FIGS. 1 and 2A) are arranged to be placed between sidewalls 104 and 106 such that the baffles rest on the top of container 200. When container 200 is filled within a liquid, the liquid therein would displace the baffles. To avoid this, a plurality of retainer covers, or retaining covers 900, are removably connected to sidewalls 104 and 106 and over the baffles, thereby maintaining the baffles in a position on top of filled container 200. Retaining covers 900 are described further infra.

FIG. 2C shows a rear view of apparatus 100 arranged within shipping container 2 The baffles, shown generally in FIGS. 1 and 2A, are removed from apparatus 100 and container 200 is show substantially empty. Shipping container 2 may include at least one of rail 10, mounted one either of side walls 6 or 8, or a pair of rails mounted on each of sides walls 6 or 8. It should be appreciated that rail 10 is generally known within the art of shipping containers or trailers, as the rail provides a plurality of mounting locations that can accept hooks, dividers, spacers, shelves (across a pair of rails on opposite side walls), and the like. As shown in FIG. 2C, hooks 12 are removably mounted on rail 10 on sidewall 6. The empty liquid container, container 200, is removably attached to retraction line 250, where line 250 is removably attached to hooks 12, e.g., resting on each of hooks 12 and having its respective terminating ends secured to one or more of a pair of end hooks of hooks 12 or rail 10. Retraction line 250 may comprise a steel rope, a wire rope, etc., such that clips 252 may be removable secured, in a translatable manner, to retraction line 250. Clips 252 may take a plurality of forms, such as but not limited to carabiner clips, locking connector loops, cable seals, etc. Clips 252 are preferably removably attached to an edge of container 200, where a plurality of one or more of grommets or apertures may be arranged proximate an edge of container 200. This configuration allows empty container 200 to be removably secured to retraction line 250 such that empty container 200 may be translated along retraction line 250 in a direction towards front wall 4 of shipping container 2, thus creating space within shipping container 2 and allowing a single operator to “collapse” or “condense” empty container 200. Inversely, empty container 200 may be “expanded” or “elongated” in direction from front end wall 4 to rear end wall 110 of apparatus 100, where inlet/outlet tube 550 of empty container 200 can be connected to valve 502, forming fluid conduit 500, in preparation for filling.

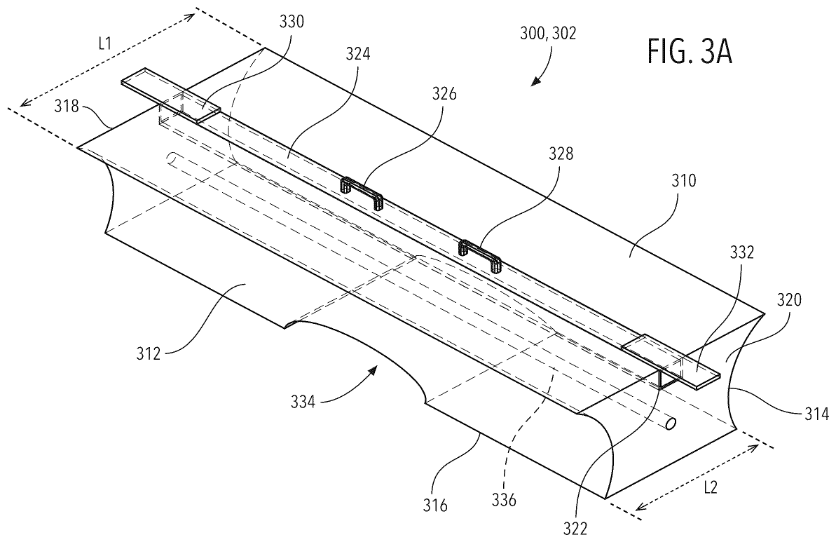

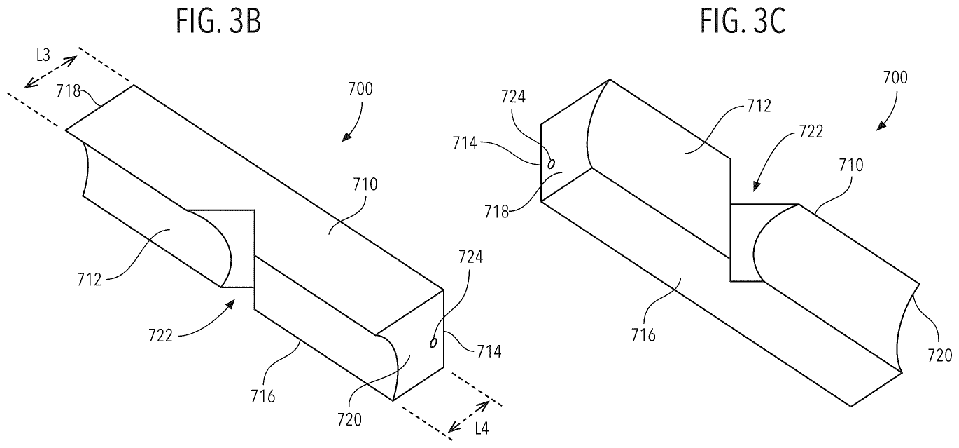

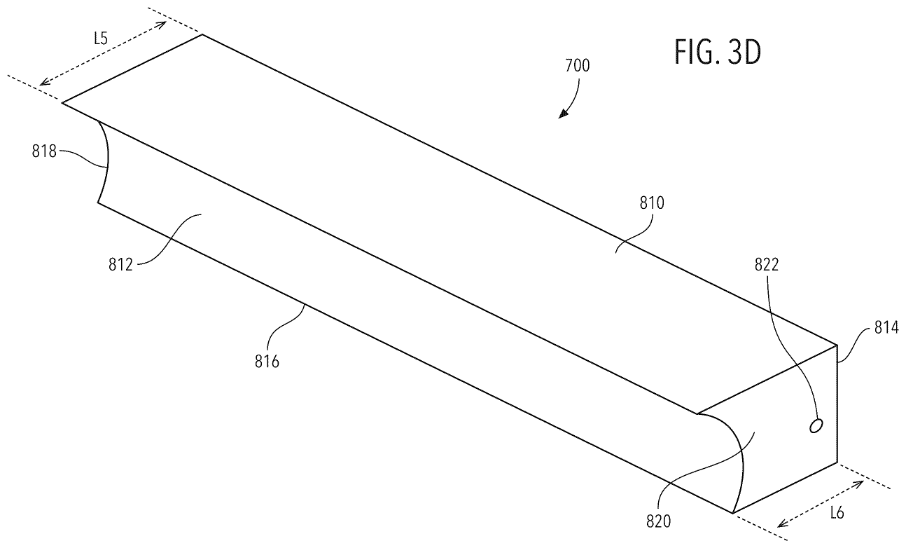

In reference to FIGS. 3A through 3C, the present invention (e.g., apparatus 100 shown in FIG. 1) is intended to utilize one or more of baffles 300, 302, 700, or 800. Preferably, in a non-limiting fashion, the apparatus utilizes each of baffles 300, 302, 700, and 800, as shown in FIGS. 1 and 2A.

Baffles 300 and 302, i.e., the middle baffles, are illustrated in FIG. 3A and are substantially identical. The middle baffles may comprise top face 310, bottom face 316, first concave face 312, second concave face 314, first side face 318, and second side face 320. Top face 310 has length L1 and bottom face 316 has length L2, where L1 is greater than L2. This arrangement makes the portion of concave faces 312 and 314 extending downwardly from top face 310 overhang or extend past the portion of concave face 312 and 314 extending upwardly from bottom face 316. Concave faces 312 and 314 are curvilinear, thereby forming a redirect for liquid movement in a direction away from the respective concave faces. Channel 322 is disposed within top face 310 and is arranged to house support beam 324 therein. Preferably, support beam 324 is fixedly secured within channel 322 and support beam 324 is preferably hollow having a polygonal cross-section to withstand compressive forces applied from the direction of one or more of side faces 318 and 320. Support beam 324 may include handles 326 and 328 attached thereto and extending therefrom. In a preferable embodiment, support beam 324 may also include extensions 330 and 332 fixedly secured on a top surface thereof and extending past the respective terminal ends of support beam 324. Extensions 330 and 332 may resemble rigid plates and are designed to rest on the top of each side wall of the frame (See FIG. 1, side walls 104 and 106 of frame 102), such that support beam 324 is positioned between the side walls of the frame, thereby preventing the side walls from collapsing in a direction towards each other. The middle baffles may also include passageway 334, e.g., an arcuate cutout disposed within bottom face 316, concave face 312 and concave face 314. In some embodiments, the middle baffles may also include a secondary support member embedded therein, e.g., internal support member 336, which may be comprised of a solid and/or hollow rod, or could be substantially similar to support beam 324.

FIGS. 3B and 3C illustrate perspective views of rear end baffle 700. As shown in FIG. 1, rear end baffle 700 is arranged to be removably placed proximate rear end 110 of frame 102. Rear end baffle 700 generally comprises top face 710, bottom face 716, concave face 712, and planar face 714 (or back face). Top face 710 has length L3 and bottom face 716 has length L4, where L3 is greater than L4. This arrangement makes the portion of concave face 712 extending downwardly from top face 710 overhang or extend past the portion of concave face 712 extending upwardly from bottom face 716. Concave face 712 is curvilinear, thereby forming a redirect for liquid movement in a direction away from the respective concave face. Rear end baffle 700 may also include cutout 722 disposed within one or more of concave face 712, top face 710, and bottom face 716 and is adapted to allow a portion of the fluid conduit of the present invention to rest at least partially therein, described further infra. Additionally, rear end baffle 700 may also include a support member embedded therein, e.g., internal support member 724, which may be comprised of a solid and/or hollow rod, or could be substantially similar to support beam 324, shown in FIG. 3A.

FIG. 3D illustrates a perspective of front end baffle 800. As shown in FIG. 1, front end baffle 800 is arranged to be removably placed proximate front end 108 of frame 102. Front end baffle 800 generally comprises top face 810, bottom face 816, concave face 812, and planar face 814 (or back face). Top face 810 has length L5 and bottom face 816 has length L6, where L5 is greater than L6. This arrangement makes the portion of concave face 812 extending downwardly from top face 810 overhang or extend past the portion of concave face 812 extending upwardly from bottom face 816. Concave face 812 is curvilinear, thereby forming a redirect for liquid movement in a direction away from the respective concave face. Additionally, front end baffle 800 may also include a support member embedded therein, e.g., internal support member 822, which may be comprised of a solid and/or hollow rod, or could be substantially similar to support beam 324, shown in FIG. 3A.

In reference to FIG. 3A through 3D, it should be appreciated that any material known, or hereinafter developed may be used to construct the baffles (e.g., baffles 300, 302, 700, and 800) of apparatus 100 so long as the baffles have energy-absorbing characteristics, i.e., when liquid within container 200 applies force onto one or more of the surfaces of the baffles, particularly the concave faces, the baffles may absorb those forces, or dampen those forces, and also redirect those forces away from the respective concave face. In a preferred configuration, the baffles may be comprised of a high-density foam material, open or closed cell, or any other suitable material capable of absorbing the energy of shifting liquid within the tank and may be formed in various thicknesses. Each of baffles 300, 302, 700, and 800 may be monolithic, or can be comprised of multiple sections formed together.

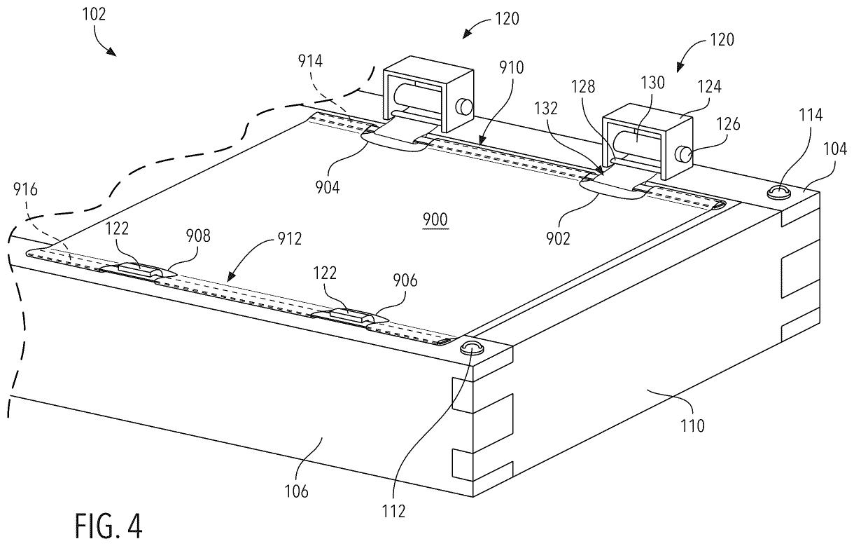

FIG. 4 is a partial perspective view of frame 102 of the apparatus, specifically showing retaining cover 900 and its respective attachment mechanisms. FIG. 4 also illustrates pins 112 and 114 which allow rear end wall 110 to be removed from side walls 104 and 106.

As previously discussed supra and in view of FIG. 2B, retaining cover 900 is the primary element which retains all of the baffles within frame 102. Each of retaining cover 900 requires a pair of adjustable connectors 120 and a pair of hooks 122, e.g., a ratio of 1:2:2, respectively. Although the representative configuration in FIG. 4 illustrates the aforementioned ratio, one having skill in the art will appreciate that the quantity of covers, adjustable connectors, and hooks, is variable and foreseeably can be modified to reduce/increase components as necessary. Retaining cover 900 includes slots 902, 904, 906, and 908, where slots 902 and 904 allow support member 914, contained within sleeve 910, to be visible and accessible. Sleeve 910 may be formed by “rolling” a longitudinal end of retaining cover back onto itself and affixing that end to form sleeve 910. In a preferred configuration, sleeve 910 is closed at its terminating ends, thereby maintaining support member 914 therein. Support member 914 may comprise a rigid rod, beam, etc. Similarly, slots 906 and 908 allow support member 916, contained within sleeve 912, to be visible and accessible. Sleeve 912 may be formed by “rolling” a longitudinal end of retaining cover back onto itself and affixing that end to form sleeve 912. In a preferred configuration, sleeve 912 is closed at its terminating ends, thereby maintaining support member 916 therein. Support member 916 may comprise a rigid rod, beam, etc.

In one possible embodiment, adjustable connector 120 may comprise housing 124, which substantially is U-shaped and includes spool 126 rotatably secured therethrough. Spool 126 is configured to house tether 130, allowing an excess of tether 130 to be stored within housing via rolling onto spool 126. Tether 130 is attached to spool 126 at one end (not visible) and includes loop 132 at its opposite end. Preferably, the end of tether 130 that has loop 132 is fed underneath rod 128 which assists in preventing upward movement of attached retaining cover 900. Adjustable connectors 120 are disposed on a top of surface of one of side walls 104 or 106. Preferably, loop 132 is permanently wrapped around an exposed portion of support member 914, e.g., the portions of support member 914 within one or more of slots 902 or 904, however, alternative attachment methods, such as removable options, are contemplated within the scope of the appending claims.

Hooks 122 are disposed on a top surface of one of side walls 104 or 106, preferably opposite adjustable connector 120. Hooks 122 are arranged to engage an exposed portion of support member 916, e.g., the portions of support member 916 within one or more of slots 906 and 908. Once hooks 122 are engaged with support member 916, the spools of adjustable connectors 120 may all be tightened, thereby pulling retaining cover 900 taught between hooks 122 and adjustable connectors 120. As such, adjustable connectors 120, specifically, spool 126, may include a rachet mechanism which prevents slack of tether 130 from being released until the rachet mechanism is disengaged. In alternative embodiments, spools of adjacent adjustable connectors may be connected, such that both spools may be wound/unwound at the same time.

Preferably, retaining cover 900 is a Kevlar® fabric, or an equivalent having substantially comparable strength, sheer-resistant, and tear-resistant, characteristics. Since retaining cover 900 is configured to maintain the baffles in a position over a filled fluid tank within the frame, the hooks, the tethers, the adjustable connectors with their respective components, are all heavy-duty and preferably metal.

In reference to FIGS. 2C and 4, hooks 12 of rail 10 (when placed on side wall 8) could be used to removably store retaining cover 900, such that hooks 12 could engage support member 916, raising retaining cover 900 and keep it out of frame 102 for when frame 102 is used for dry goods (e.g., when the liquid container is empty and removed therefrom).

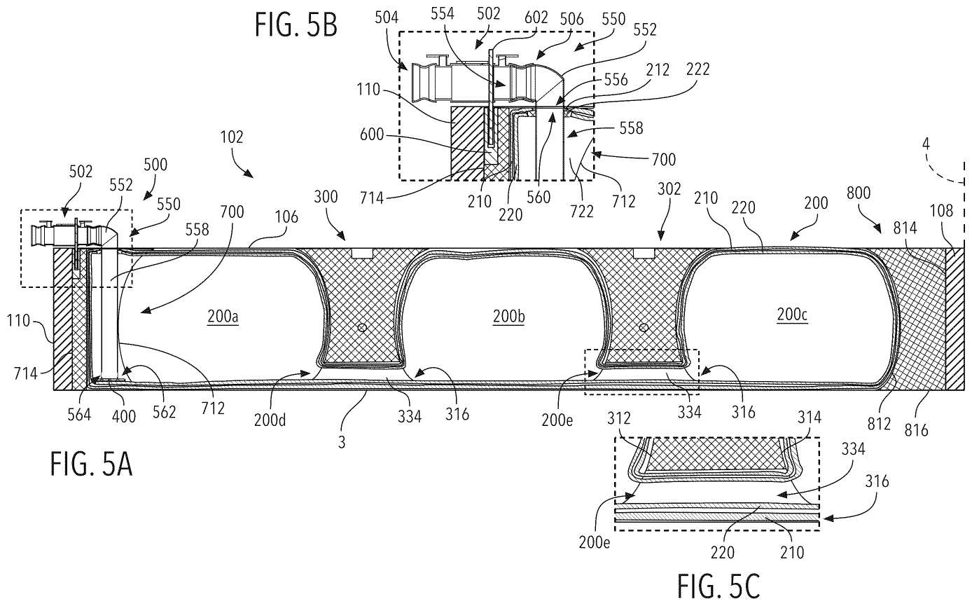

The following description should be taken in view of FIGS. 1 through 4 and in view of FIGS. 5A through 5C. FIG. 5A shows a cross-sectional view of apparatus 100 taken generally along line 5A-5A in FIG. 1, and FIGS. 5B and 5C generally illustrate enlarged portions taken from FIG. 5A. As shown in FIG. 5A, fluid container 200 is generally depicted as being filled with a fluid, e.g., bulk liquid and/or fluid cargo, positioned within frame 102, and pinned within frame 102 by baffles 300 and 302—along with a plurality of retaining members (See FIG. 4), holding baffles 300, 302, 700, and 800 within frame 102, which retaining members are removed for clarity of illustration. Baffles 300, 302, 700, and 800 substantially form sections within fluid container 200. Baffles 700 and 300 form section 200a, baffles 300 and 302 form section 200b, and baffles 302 and 800 form section 800. Passageway 334 of each of baffles 300 and 302 creates passages 200d and 200e, where passage 200d fluidly connects sections 200a and 200b and passage 200e fluidly connects sections 200b and 200c. As generally illustrated in FIGS. 5A and 5C, bottom face 316 of both baffles 300 and 302 is placed on top of fluid container 200, specifically outer line 210, in other words, baffles 300 and 302 preferably do not rest on floor 3 of shipping container 2 (See FIG. 1), whereas baffles 700 and 800 preferably rest on floor 3.

In some embodiments, fluid container 200 is comprised of a liquid impermeable outer liner, e.g., outer liner 210 and a liquid impermeable inner bladder, e.g., inner bladder 220, arranged within outer liner 210. As such, outer liner 210 may include a sealable opening disposed along its length, allowing liner blader 220 to be placed therein. This opening may include a waterproof zipper apparatus allowing the opening of outer line 210 to be closed while maintaining a liquid impermeable configuration. As shown in FIG. 5B, outer liner 210 includes seal 212 which is arranged to sealable wrap around a portion of fluid conduit specifically, inlet/outlet tube 550, in a water-tight manner. Similarly, inner bladder 220 includes seal 222 which is arranged to sealable wrap around a portion of fluid conduit 500, specifically, inlet/outlet tube 550, in a water-tight manner. Seal 222 could be fixedly secured to an outer surface of inlet/outlet tube 550 via known methods such as ultrasonic welding or alternative contemplated within the art, so long as the water-tight configuration is maintained. Alternatively, seal 222 could be affixed to a flange circumscribing a portion of inlet/outlet tube 550.

In a possible arrangement, inner bladder 220 is a liquid-impermeable material. Inner bladder 220 may be comprised of a single-ply or two-ply thermoplastic, such as a food-grade polyethylene, or other similar thermoplastics which can form a liquid-impermeable and collapsible/deformable liquid container, which may be comprised of varying thicknesses such that liquid-impermeable characteristics are maintained. In a preferred arrangement, outer liner 210 is a liquid-impermeable material, outer liner 210 may be comprised of a thermoplastic, single-ply or two-ply, such as a thermoplastic coated with Polyvinylidene fluoride or polyvinylidene difluoride (PVDF), e.g., the “Soltis 502” made by Ferrari Serge Sas.

Any material known, or hereinafter developed may be used to construct the inner bladder and the outer liner of the liquid container, as long as such material provides waterproof and liquid-impermeable characteristics to prevent leakage from the liquid container when the container is forcibly contained within the frame by the respective baffles and is filled with a liquid.

In a preferrable, but not limiting embodiment, one or more of inner bladder 220 or inlet/outlet tube 550, may be arranged as single-use and disposable. Although reusable configurations are contemplated within the scope of the appending claims, it should be noted that single-use and disposable embodiments of the aforementioned, has particular benefits, namely, avoidance of the certified wash center fees associated with a wash of a liquid container and also efficiency, meaning that a necessary dry-time of a washed reusable bulk liquid container (e.g., at least two hours for collapsible and expandable designs) is avoided all together. Lastly, a single-use and disposable bulk liquid container is the most sanitary option for transporting bulk liquid cargo.

In one embodiment of apparatus 100, fluid conduit 200 is arranged to be at least partially positioned within cutout 722 of baffle 700. Fluid conduit 200 may be comprised of valve 502 and inlet/out tube 550, which are fluidly connected in a removable manner, providing an inlet and/or outlet, into or out of fluid container 200, specifically inner bladder 220. As discussed supra, inlet/outlet tube 550 is preferably affixed to inner bladder 220 in a water-tight configuration, thus, making inlet/outlet tube 550 the single outlet and inlet to inner blader 220. Best shown in FIG. 5B, a portion of inlet/outlet tube 550 is removably secured to valve 502, thereby fluidly connecting valve 502 to inner bladder 220. In some embodiments, valve 502 has first opening 504 and second opening 506. In some embodiments, inlet/outlet tube 550 comprises elbow 552 which has first opening 554 and second opening 556, where second opening 556 connects to elongated section 558, specifically, first end 560 of elongated section 558. First opening 554 of elbow 552 is arranged to be removably and at least partially seated within second opening 506 of valve 502, thereby fluidly connecting elbow 552 to valve 502. First opening 554 of elbow 552 is configured with a cam-lock fitting that is designed to mate with a corresponding cam-lock fitting of second opening 506 of valve 502. First opening 504 of valve 502 may also be configured with a cam-locking fitting that is designed to removably connect to an external conduit, allowing fluid to be pumped into inner blade 220 or to allow fluid to be pumped out of inner bladder 220. Opposite first end 560 of elongated section 558 is second end 562, which is positioned within inner blade 220 proximate floor 3. First end 560 and second end 562 define the respective openings of elongated section 558. Preferably, second end 562 also includes plurality of apertures 564 therein, proximate second end 562 and circumscribing elongated section 558, allowing fluid to enter elongated section 558 is second end 562 is abutting an internal surface of inner bladder 220. In one possible arrangement, inner bladder 220 may include buffer 400, positioned directly below end 562 of elongated section 558, and preferably having a greater diameter than end 562. Buffer 400 is comprised of one or more of an additional layer of material, which may be the same material as inner bladder 220, or a thicker material than inner bladder 220, e.g., the same material as outer liner 210, and serves as an additional layer of protection for inner bladder 220 such that end 562 of elongated section 558 cannot puncture, tear, etc., inner blade 220 when end 562 is resting on the internal surface of inner bladder 220.

In one embodiment, valve 502 is affixed to movable plate 602, which is translatably attached to mounting plate 600, where mounting plate 600 is connected to rear wall 110. Movable plate 602 is arranged within mounting plate 600 and can be selectively translated in the vertical direction, thereby moving valve 502 and a connected inlet/outlet tube 550 up and down. Therefore, in use, end 562 of elongated section 558 can be lowered such that end 562 touches the internal surface of inner bladder 220, specifically buffer 400, or can be raised such that there is a space between end 562 of elongated section 558 and the internal surface of inner bladder 220, specifically buffer 400. In use, when fluid is pumped into inner bladder 220 via valve 502 and inlet/outlet tube 550, it is preferable that end 562 is raised to allow the least resistance of the fluid filling inner bladder 220. When fluid is removed from inner bladder 220, via valve 502 and inlet/outlet tube 550, it is preferable that end 562 is lowered to contact buffer 400 or the internal surface of inner bladder 220, allowing plurality of apertures 564 of elongated section to be positioned at the lowest possible point to afford the highest level of fluid evacuation of inner bladder 220. The vertical translation afforded by movable plate 602, e.g., lowering end 562, along with the force of baffles 300 and 302 being applied onto inner bladder 220, allows a substantially complete emptying of fluid from inner bladder 220, unlike a simple gravity-fed outlet of prior solutions.

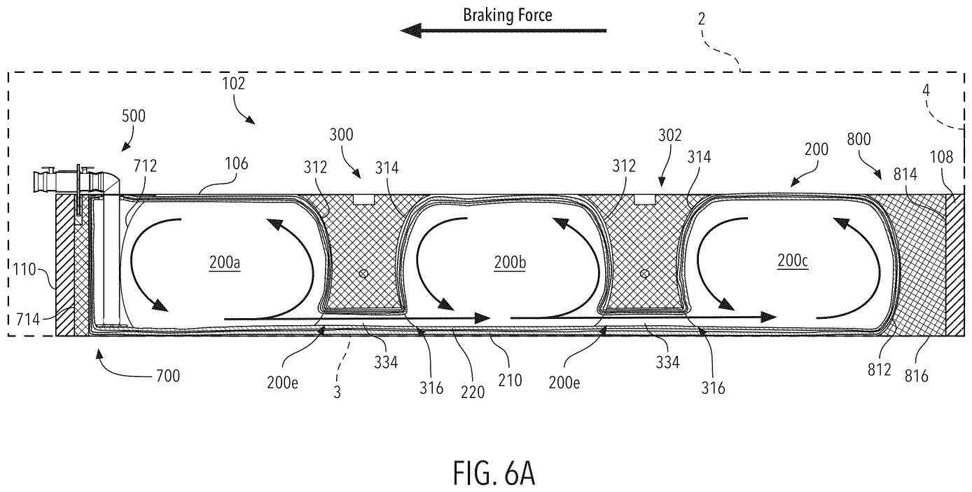

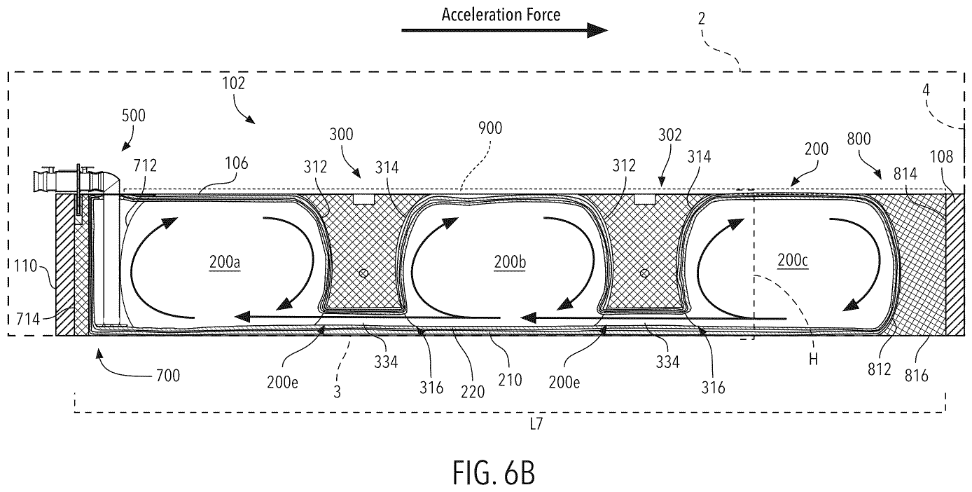

The following description should be taken in view of the aforementioned figures and FIGS. 6A through 6B, which generally is the cross-sectional view of FIG. 5 generally illustrating fluid movement within fluid container 200 of apparatus 100. Specifically, FIG. 6A generally shows how fluid moves and interacts with baffles 300, 302, 700, and 800 within fluid container 200 when shipping container 2 is subjected to braking force and FIG. 6B generally shows how fluid moves and interacts with baffles 300, 302, 700, and 800 within fluid container 200 when shipping container 2 is subjected to acceleration force. Each of the end baffles, baffles 700 and 800 have one concave face, concave faces 712 and 812, respectively. Each of the middle baffles, baffles 300 and 302 have a pair of oppositely facing concave faces, concave faces 312 and 314. All of the concaves faces are designed to substantially redirect fluid within liquid container 200 away from the respective concave faces and in a direction towards floor 3 of shipping container 2. This configuration substantially reduces the liquid sloshing effect and the forces associated therewith, when shipping container 2 has braking (declaration) forces and acceleration forces applied thereto. Additionally, the sections created by baffles 300 and 302 prevent a substantial amount of fluid or liquid within liquid container 200 from flowing towards front wall 108 when a braking force is applied to shipping container 2 or from flowing towards rear wall 110 when an acceleration force is applied to shipping container 2. Instead, less fluid or liquid travels between sections 200a, 200b, and 200c via passages 200d and 200e formed by passageways 334 of baffles 300 and 302, further reducing the force the liquid or fluid may impart on shipping container at either ends thereof. Meanwhile, as shown in FIG. 4, the retaining members are also applying a downward force on fluid container 200, along with baffles 300 and 302, which helps maintain a lower center of gravity of the liquid within liquid container 200. All of these aspects of apparatus 100 provide for a safer method of transporting bulk liquid cargo within a shipping container.

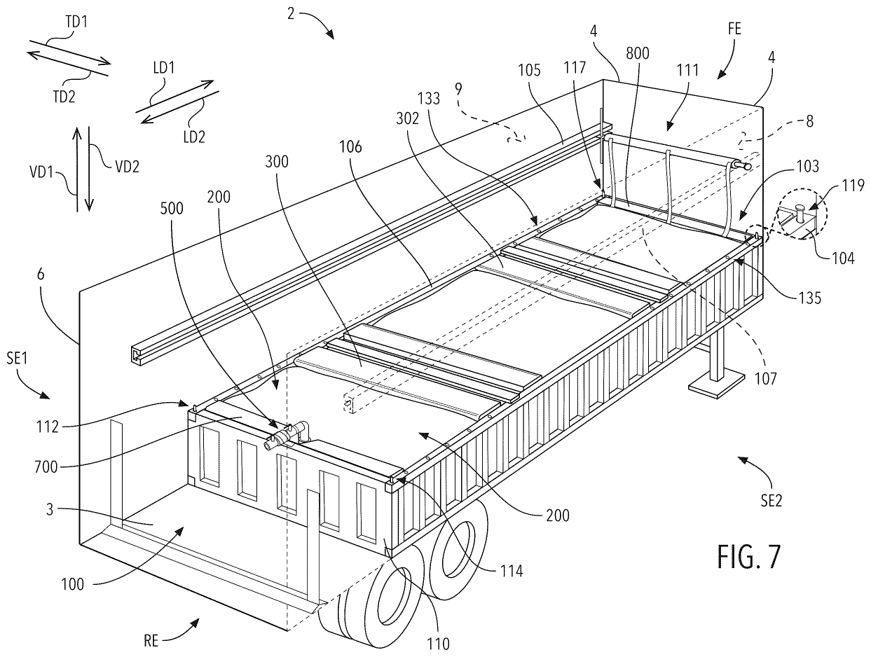

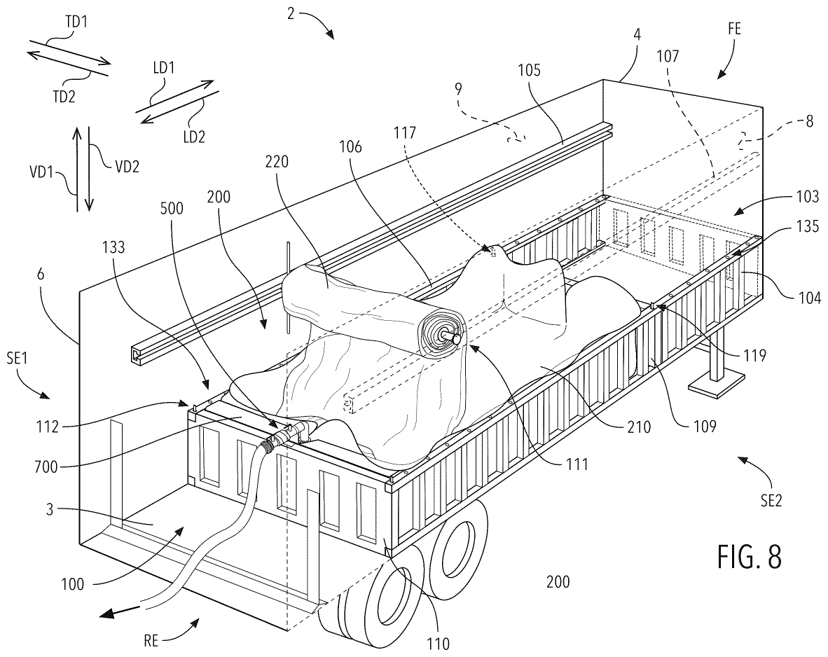

Adverting now to FIGS. 7 through 10, which generally depict a further aspect of an apparatus for transporting liquid, specifically FIGS. 7 and 8 generally show a perspective view of the apparatus and its frame arranged within an embodiment of a shipping container (or equivalents), particularly a shipping container arranged to be transported by a tractor trailer.

This embodiment introduces significant enhancements aimed at improving operational flexibility, efficiency, and safety. A key improvement addresses the challenge of transporting high-density liquid cargo. Often, the maximum legal highway weight is reached before the liquid container is completely full by volume. This results in significant free space, particularly a lower fill height, which can lead to dangerous liquid surge and sloshing during transit. To solve this, the present disclosure introduces a frame with adjustable end members. An operator can reduce the longitudinal length of the containment area, effectively “squeezing” the flexible container. This forces the lower volume of high-density liquid to reach an optimal fill height, minimizing both vertical and longitudinal free space and substantially improving vehicle stability since the filled liquid container will press against the floor of the shipping container, each of the members of the adjustable frame, and at least one retaining cover secured on top of the adjustable frame, while also being pinned down by at least one baffle. To further reduce free space, a liquid conduit that fills or empties the flexible container, is designed with an integrated air release mechanism or air bleeder that purges any excess or entrapped air from within the flexible container. A second major improvement addresses the issue of “heel,” or the residual liquid product that remains trapped in the container after emptying. A reel system is integrated into the frame. During the final stages of evacuation, the reel is used to lift a portion of the collapsible container, introducing a gravity-assist that directs the remaining liquid towards the outlet. This ensures a more complete evacuation of the cargo, reducing product waste and improving overall transport yield. Additionally, the reel provides a simple and controlled method for collapsing and storing the empty liquid container, streamlining the process of converting the shipping container back to a dry freight carrier and making the task manageable for a single operator.

Turning now to FIG. 7, a perspective view of this further aspect of apparatus 100 is shown. Apparatus 100 is installed within shipping container 2, which includes floor 3, front wall 4, and side walls 6 and 8. In this embodiment, the frame is adjustable frame 103. A key feature of this adjustable frame is that side walls 104 and 106 of adjustable frame 103, include plurality of apertures 135 and 133, respectively. Front wall 109 and rear wall 110 can be removably and adjustably positioned between these side walls or frame members. An operator can secure front wall 109 and rear wall 110 at various longitudinal positions (in directions LD1, LD2) by inserting pins 119 and 112 through corresponding apertures in the end walls and side walls 104, 106. This allows the operator to precisely define the internal area occupied by liquid container 200 to match the cargo volume and comply with the particular highway weight.

This embodiment also introduces a pair of rails, rails 105, 107, which are fixedly secured to side walls 8 and 6, respectively, of shipping container 2. Reel 111 is rotatably and translatably mounted on these rails, here shown proximate the front end FE of the shipping container. The ends of reel 111 are seated within channels formed in the rails 105 and 107, allowing the reel to rotate and move longitudinally. Reel 111 is operatively arranged to wind and collapse the liquid container 200 toward the front wall 4, as well as to assist in the emptying process. Also shown are collapsible liquid container 200, middle baffles 300 and 302, rear end baffle 700, front end baffle 800, and fluid conduit 500. For clarity in illustrating adjustable frame 103 and reel 111, any retaining covers are not shown in FIG. 7; however, it is to be understood that in a preferred embodiment, one or more retaining covers would be utilized to secure the baffles onto the liquid container 200, as shown in FIGS. 4 and 9-10.

FIG. 8 shows a perspective view illustrating apparatus 100 in operation, specifically during the emptying and collapsing of liquid container 200. This view also demonstrates the function of reel 111, emptying assistance, and storage of liquid container 200. After at least the middle baffles and at least one retaining cover have been removed and the majority of the liquid has been drained from liquid container 200 via fluid conduit 500, reel 111 is utilized.

As shown, reel 111, which is mounted on rails 105 and 107, is rotated to wind collapsible liquid container 200 onto itself. This action pulls container 200, comprising outer liner 210 and inner bladder 220, forward toward front end FE of shipping container 2. This process serves a dual purpose. Firstly, by progressively lifting container 200 off floor 3, it creates a gravity-assist, directing any residual liquid product, or “heel,” toward fluid conduit 500 at the rear of the apparatus. This ensures a more complete evacuation of the cargo and reduces product waste. Secondly, this action provides a controlled and efficient method for collapsing the container into a compact form at the front of the shipping container, freeing up the majority of the internal space for the transport of dry freight. The entire process is designed to be managed by a single operator, significantly improving operational efficiency.

While the embodiment shown implies manual operation, it is contemplated that reel 111 could be motorized. A motorized system, for example, driven by an electric motor, could be used to automate the winding process, further reducing the manual effort required by the operator and increasing the speed of conversion between liquid and dry freight transport.

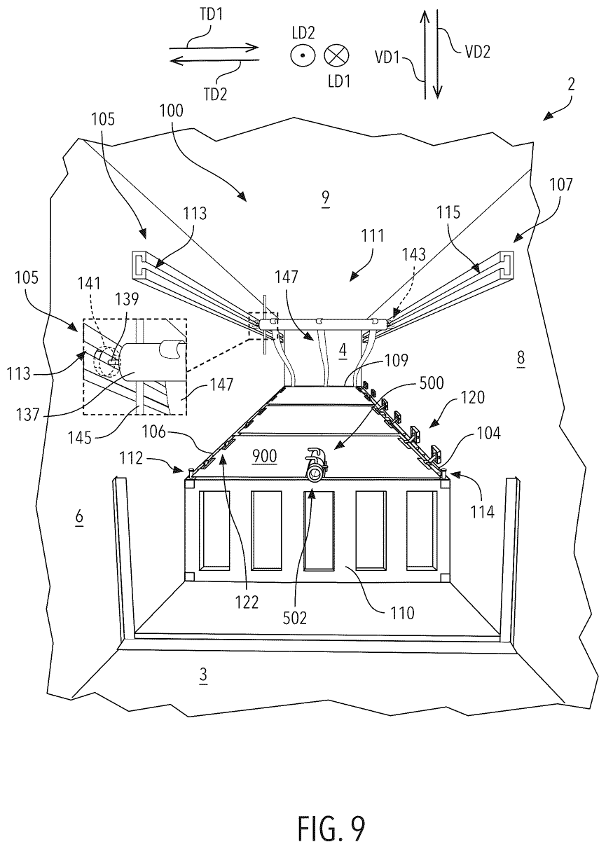

FIG. 9 shows a rear view of the apparatus 100, looking toward front wall 4 of shipping container 2 and providing an enlarged view reel 111. A pair of upper rails, rails 105, 107, are fixedly secured longitudinally along interior side walls 8 and 6 of shipping container 2. These rails are designed with channels 115 and 113, respectively, which are configured to accept and support reel 111. Reel 111 itself comprises central pole 139 around which wrap body 137 is formed, and preferably, has a greater diameter than pole 139. The first and second ends of the reel, ends 141 and 143, are seated within these channels 113 and 115. This mounting arrangement allows reel 111 to perform two distinct motions: it can rotate within the channels to wind or unwind the liquid container, and it can translate longitudinally (in directions LD1, LD2) along the length of the rails. Handle 145 is shown attached to the reel, providing means for an operator to manually impart rotational force. Extending from wrap body 137 is at least one tether, e.g., tether 147, which is adapted to connect to an of the collapsible liquid container (not shown), preferably inner bladder 220 (See FIG. 8) at an end opposite of conduit 500, facilitating winding and collapsing of liquid container 200 during emptying and/or storage.

This view provides context for how the reel mechanism exists when apparatus 100 is in a liquid-filled state and ready for transportation. One or more of retaining cover 900 is shown in its secured position, stretched across the top of the apparatus and pinning at least the middle baffles on top of a filled liquid container. It is held in place by adjustable connector 120 on one side and hook 122 on the opposite side, which engage with the respective side frame. This arrangement is detailed and shown further in FIG. 4, described supra. Fluid conduit 500 is positioned proximate rear wall 110. Rear wall 110 is shown secured to side walls 106 and 104 by pins 112 and 114, respectively, and opposite thereof, secured by its own pins to side walls 104 and 106, adjustable front wall 109 is positioned proximate front wall 4 of shipping container 2.

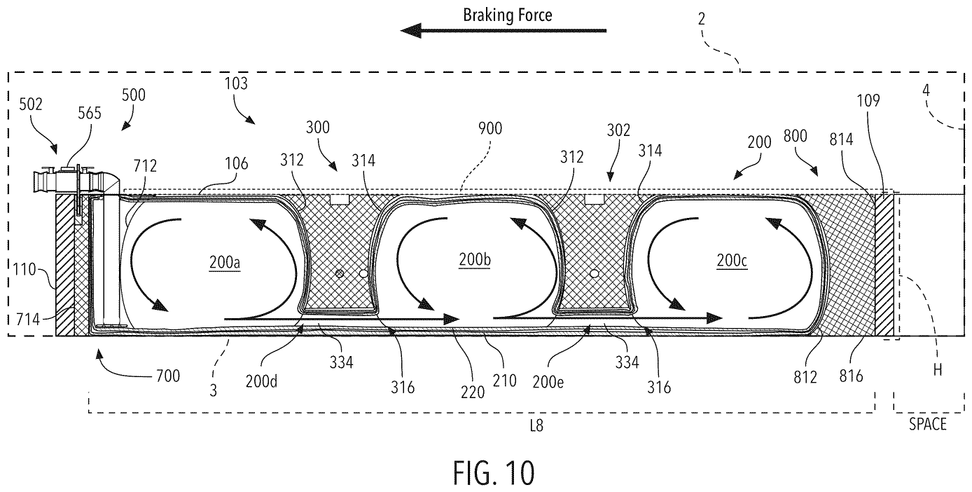

FIG. 10 presents a cross-sectional view of adjustable frame 103 when transporting high-density liquid cargo. This configuration may be contrasted with FIG. 6B, which, in this context, illustrates a scenario with a lower-density liquid cargo that fills a larger volume, thus corresponding to length L7 of frame 102—which is not longitudinally adjustable.

When transporting high-density liquids, the maximum legal highway weight limit is often reached before liquid container 200 is filled to its maximum volumetric capacity. Without the adjustability of frame 103, this lower volume would not reach the top of the frame, creating significant vertical free space. This space would prevent the retaining cover from contacting the container and would allow for dangerous vertical sloshing and freer movement of liquid between the baffled sections 200a, 200b, and 200c, increasing liquid surge and thus, decreasing the stability of container 2.

FIG. 10 illustrates how adjustable frame 103 solves this issue. By moving one or more of the end walls, such as front wall 109, away from front wall 4 and towards rear wall 110, the longitudinal length of the containment area is reduced to a new length L8, which is less than the length L7 in FIG. 6B. This reduction in length effectively “squeezes” the lower volume of high-density liquid, forcing it to fill the container up to the preferable height H.

At this preferable height H, liquid container 200 is fully constrained, being in contact with all surrounding surfaces: floor 3, side walls, end walls 109 and 110 (via baffles 700 and 800), and, critically, the one or more retaining covers 900. As shown, one or more retaining cover 900 is secured over the baffles 300 and 302 (See FIGS. 4 and 9), applying a constant downward force. By ensuring filled liquid container 200 reaches height H and eliminating vertical free space, the baffles remain in full contact with the filled liquid container, and the entire system is pinned securely. This configuration prevents, or least greater reduces, vertical sloshing and optimally restricts fluid movement, creating a highly stable and secure liquid mass for the safe transport of high-density cargo, allowing for a greater selection of bulk liquid cargo or bulk liquid slurries, or “fluid” cargos, to be transported by apparatus 100.

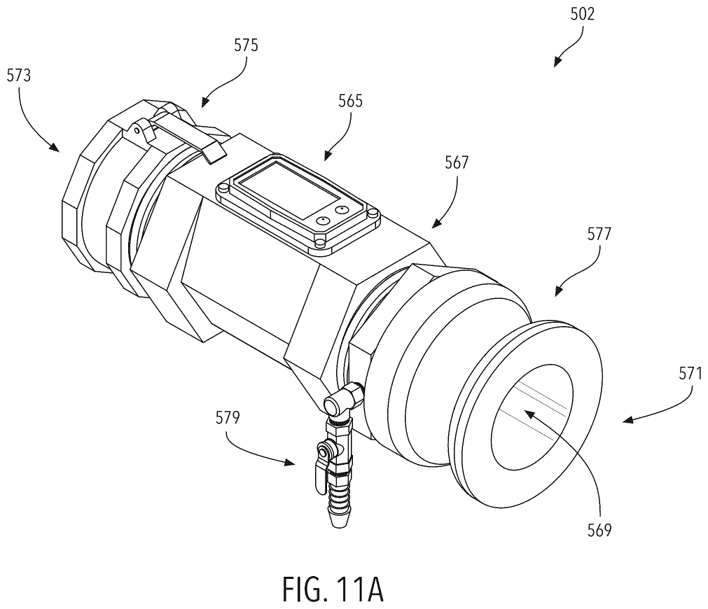

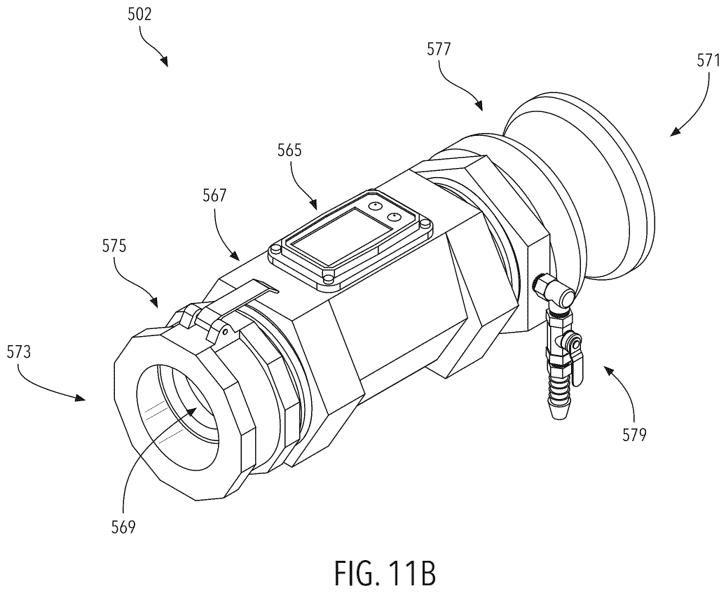

FIGS. 11A and 11B illustrate a preferred embodiment of valve 502 of the fluid conduit, configured as a petcock valve with an integrated air bleeder. FIG. 11A provides a perspective view of the valve, while FIG. 11B shows the same valve from an alternative perspective.

As shown, valve 502 comprises main body 567 that defines fluid passageway 569 extending between first end 571 and second end 573. In this preferred embodiment, first end 571 is illustratively configured with female camlock coupler 577, and second end 573 is illustratively configured with male camlock adaptor 575. These cam and groove fittings provide quick, secure, and leak-proof connections to both the inlet/outlet tube (e.g., 550 in FIG. 5B) of the liquid container and an external filling or emptying conduit (See FIG. 8). It is contemplated that the type of fitting on each end can be interchanged as needed for different operational or connection requirements, and thus, these cam and groove fittings are removably affixed to main body 567.

Integrated into main body 567 is flow meter 565, which is configured to measure and display the volume and/or flow rate of the liquid passing through fluid passageway 569. A key feature of this embodiment is air bleeder 579, which is in fluid communication with main fluid passageway 569. In use, after the liquid container is filled, air bleeder 579 can be opened to purge any entrapped air from within the inner bladder. This purging action is critical as it further reduces the total free space within the filled container, thereby minimizing the potential for liquid sloshing and enhancing vehicle stability during transport.

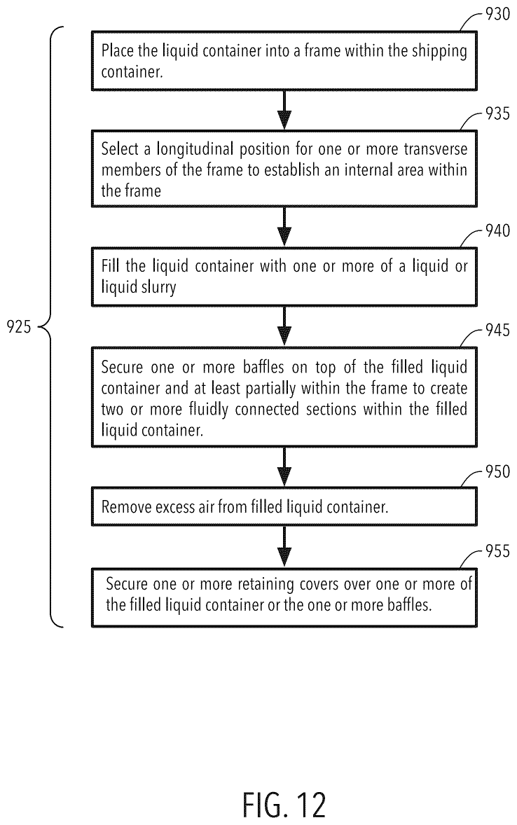

FIG. 12 generally illustrates a method (925) for reducing free space in a liquid container within a shipping container, particularly when transporting high-density liquids. The method comprises a series of steps designed to ensure the liquid cargo is transported in a safe and stable configuration.

Method 925 begins with Step 1 (930), which involves placing collapsible liquid container 200 into frame 103 within shipping container 2. This initial placement can be visualize in FIG. 8 and filled in FIG. 7, where container 200 is positioned on floor 3 between side walls 104 and 106.

Next, in Step 2 (935), an operator selects a longitudinal position for one or more traverse members of the frame, such as adjustable front wall 109 and/or rear wall 110, to establish an internal area correctly sized for the cargo volume. As shown in FIGS. 7 and 8, this may be accomplished by moving front wall 109 along side walls 104 and 106 and securing it with pins 117 and 119 in the appropriate apertures of plurality of apertures 133 and 135. This adjustment allows the frame's length to be reduced from a larger length (e.g., L7 in FIG. 6B) to a shorter length (e.g., L8 in FIG. 10), thereby ensuring a high-density, lower-volume liquid will fill liquid container 200 to its optimal height H in adjustable frame 103.

Step 3 (940) comprises filling liquid container 200 with a bulk liquid or bulk liquid slurry (or other “fluid” cargo). This is performed using fluid conduit 500, shown in detail in FIGS. 5A and 5B. The liquid enters through valve 502 and inlet/outlet tube 550, filling inner bladder 220. Valve 502 of fluid conduit 500 may include flowmeter 565 to ensure that the liquid cargo entering liquid container 200 complies with a respective highway weight.

Following the filling process, Step 4 (945) involves securing one or more baffles on top of filled liquid container 200. As illustrated in the arrangement of at least FIG. 7, and the cross-sectional of FIG. 10, at least baffles 300 and 302, placed onto filled liquid container 200, where baffles 700, and 800 are preferably “bookends” to filled liquid container. This placement creates two or more fluidly connected sections (200a, 200b, 200c) within the container, which helps to inhibit large-scale longitudinal fluid movement.

Step 5 (950) involves removing excess air from the filled liquid container. This is accomplished using air bleeder 579 on valve 502, as detailed in FIGS. 11A and 11B. After the container is filled, an operator opens air bleeder 579 to purge any air that became entrapped within the inner bladder during the filling process. This action is vital as it removes residual free space, ensuring the liquid fully occupies the container volume and further enhancing stability by minimizing sloshing potential.

Finally, in an optional, but preferred Step 6 (950), one or more retaining covers are secured over the baffles and the filled liquid container, as shown in FIG. 9 and representatively shown in FIG. 10. This action is best illustrated in FIG. 4, which shows one or more retaining cover 900 with its adjustable connectors 120 and hooks 122. The result of this step is shown in FIG. 10, where the one or more retaining cover 900 applies a downward force to pin the baffles and container firmly within the frame, ensuring maximum stability.

The foregoing description of the embodiments has been presented for purposes of illustration. It is not intended to be exhaustive or to limit the various aspects to the precise forms disclosed. The embodiments were chosen and described in order to best explain the principles of the disclosure and its practical application, thereby enabling others skilled in the art to understand the disclosure for various embodiments and with various modifications as are suited to the particular use contemplated. It is to be understood that the scope of the disclosure is defined by the appended claims.

### REFERENCE NUMERALS

2 Shipping container
3 Floor
4 Front wall
6 Side wall
8 Side wall
9 Ceiling
10 Rail
12 Hooks
100 Liquid transporting container apparatus
102 Frame
103 Adjustable frame
104 Side wall
105 Rail
106 Side wall
107 Rail
108 Front wall
109 Adjustable front wall
110 Rear wall
111 Reel
112 Pin
113 Channel
114 Pin
115 Channel
117 Pin
119 Pin
120 Adjustable connector
122 Hook
124 Housing
126 Spool
128 Rod
130 Tether
132 Loop
133 Plurality of apertures
135 Plurality of apertures
137 Wrap body
139 Pole
141 First end
143 Second end
145 Handle
147 Tether
200 Collapsible liquid container
200a Section
200b Section
200c Section
200d Passage
200e Passage
210 Outer liner
212 Seal
214 Seam
220 Inner bladder
222 Seal
224 Seam
226 Bottom
250 Retraction line
252 Clips
300 First baffle
302 Second baffle
310 Top face
312 First concave face
314 Second concave face
316 Bottom face
318 First side face
320 Second side face
322 Channel
324 Support beam
326 First handle
328 Second handle
330 First extension
332 Second extension
334 Passageway
336 Internal support member
400 Buffer
500 Fluid conduit
502 Valve
504 First opening
506 Second opening
550 Inlet/outlet tube
552 Elbow
554 First opening
556 Second opening
558 Elongated section
560 First end
562 Second end
564 Plurality of apertures
565 Flow meter
567 Main body
569 Fluid passageway
571 First end
573 Second end
575 Male camlock adaptor
577 Female camlock coupler
579 Air bleeder
600 Mounting plate
602 Movable plate
700 Rear end baffle
710 Top face
712 Concave face
714 Planar face
716 Bottom face
718 First side face
720 Second side face
722 Cutout
724 Internal support member
800 Front end baffle
810 Top face
812 Concave face
814 Planar face
816 Bottom face
818 First side face
820 Second side face
822 Internal support member
900 Retaining cover
902 Slot
904 Slot
906 Slot
908 Slot
910 Sleeve
912 Sleeve
914 Support member
916 Support member
925 Method of reducing free space
930 Step 1
935 Step 2
940 Step 3
945 Step 4
950 Step 5
955 Step 6
D Distance
H Height
FE Front end
L1 Length
L2 Length
L3 Length
L4 Length
L5 Length
L6 Length
L7 Length
L8 Length
LD1 Longitudinal direction
LD2 Longitudinal direction
RE Rear end
SE1 Side end
SE2 Side end
TD1 Transverse direction
TD2 Transverse direction
VD1 Vertical direction
VD2 Vertical direction

What is claimed is:

1. An apparatus for use in a shipping container for selectively carrying solid freight and bulk liquid freight, comprising:
a first side frame and a second side frame that both extend longitudinally with respect to the shipping container and are fixedly secured thereto;
a front frame removably affixed to and adjustably positioned between the first and second side frames along respective lengths of the side frames;
a rear frame removably affixed to and adjustably positioned between the first and second side frames along respective lengths of the side frames opposite the front frame;
a collapsible liquid container having a first end and a second end, the container further comprising: a liquid impermeable outer liner; a liquid impermeable inner bladder arranged within the outer liner; and, a fluid conduit positioned proximate the first end and in fluid communication with the inner bladder;
a reel configured to be rotatably and translatably connected to a pair of rails that extend longitudinally with respect to the shipping container, the reel having at least one tether extending therefrom and connected to the collapsible liquid container proximate the second end thereof, thereby wrapping the collapsible liquid container around the reel upon rotation of the reel; and,
at least one baffle operatively arranged to be positioned between the first and second side frames and on top of the collapsible liquid container, wherein the collapsible liquid container is adapted to be removably pinned at least partially within the frame via the at least one baffle.

2. The apparatus recited in claim 1, where the at least one baffle comprises:
a first baffle operatively arranged to be positioned between the first and second side frames and on top of the collapsible liquid container; and,
a second baffle operatively arranged to be positioned between the first and second side frames and on top of the collapsible liquid container and spaced apart from the first baffle.

3. The apparatus recited in claim 2, wherein each of the first and second baffles comprise:
a top face and a bottom face bounded by a pair of side faces;
a pair of concave faces disposed between the top and bottom faces; and,
a channel arranged within the pair of concave faces and the bottom face.

4. The apparatus recited in claim 2, wherein each of the first and second baffles comprise:
a channel disposed within the top and the pair of side faces, the channel operatively arranged to accept a support member therein.

5. The apparatus recited in claim 1 further comprising:
a front end baffle arranged at least partially within the frames and proximate the front frame, the front end baffle having:
a top face and bottom face bounded by a pair of side faces;
a concave face disposed between the top and bottom faces and facing the rear frame; and,
a rear face disposed between the top and bottom faces and facing the front frame.

6. The apparatus recited in claim 1 further comprising:
a rear end baffle arranged at least partially within the frames and proximate the rear frame, the rear end baffle having:
a top face and bottom face bounded by a pair of side faces;
a concave face disposed between the top and bottom faces and facing the rear frame;
a rear face disposed between the top and bottom faces and facing the rear frame; and,
a conduit channel disposed within the top, bottom, and concave face, wherein the conduit channel is adapted to accept the at least a portion of the fluid conduit at least partially therein.

7. The apparatus recited in claim 1 further comprising:
at least one retaining cover adapted to at least partially cover a space disposed between the side frames, the at least one retaining cover retractably secured to a top surface one of the side frames and removably secured to a top surface of the opposite side frame, the at least one retaining cover further adapted to pin the at least one baffle onto the liquid container.

8. The apparatus recited in claim 1, wherein the fluid conduit further comprises:
a longitudinal tube portion having a first end and a second end, the first end arranged within the inner bladder and the second end extending through the inner bladder and affixed thereto; and,
a connection elbow extending from the first end.

9. The apparatus recited in claim 8, wherein the fluid conduit further comprises:
a petcock valve affixed to the front frame and configured to be removably secured to the connection elbow, the petcock valve having an integrated air release mechanism.

10. The apparatus recited in claim 9, wherein the petcock valve further comprises a flow meter.

11. The apparatus recited in claim 1, wherein:
the first side frame has a first plurality of apertures disposed therein;
the second side frame has a second plurality of apertures disposed therein;
the front frame has a pair of apertures disposed therein;
the rear frame has a pair of apertures disposed therein;
one aperture of the pair of apertures of the front frame and one aperture of the first plurality of apertures configured to be substantially aligned and accept a first pin therein to secure the front frame to the first side frame;
the other aperture of the pair of apertures of the front frame and one aperture of second plurality of apertures configured to be substantially aligned and accept a second pin therein to secure the front frame to the second side frame;
one aperture of the pair of apertures of the rear frame and another aperture of the first plurality of apertures configured to be substantially aligned and accept a third pin therein to secure the rear frame to the first side frame;
the other aperture of the pair of apertures of the rear frame and another aperture of second plurality of apertures configured to be substantially aligned and accept a fourth pin therein to secure the rear frame to the second side frame.

12. The apparatus recited in claim 1, wherein each rail of the pair of rails comprises a channel, each of the channels configured to accept respective ends of the reel therein.

13. The apparatus recited in claim 1, wherein the reel comprises at least one handle extending therefrom.

14. A method for reducing free space in a liquid container within a shipping container:
place the liquid container into a frame within the shipping container;
select a longitudinal position for one or more traverse members of the frame to establish an internal area within the frame;
fill the liquid container with one or more of a bulk liquid or liquid slurry; and,
secure one or more baffles on top of the filled liquid container and at least partially within the frame to create two or more fluidly connected sections within the filled liquid container.

15. The method recited in claim 14 further comprising the step of remove excess air from the filled liquid container.

16. The method recited in claim 14 further comprising the step of secure one or more retaining covers over one or more of the filled liquid container or the one or more baffles.

17. An apparatus for use in a shipping container for selectively carrying solid freight and bulk liquid freight, comprising:
a frame adapted to be secured within the shipping container;
a collapsible liquid container positioned within the frame;
a pair of rails adapted to be secured longitudinally within the shipping container; and,
a reel rotatably and translatably mounted on the pair of rails, the reel being operatively arranged to wind the collapsible liquid container thereon to collapse the container.

18. The apparatus recited in claim 17, wherein the reel comprises at least one handle extending therefrom configured to receive a rotational force to wind the collapsible liquid container.

19. The apparatus recited in claim 17, further comprising a tether connecting the reel to the collapsible liquid container, wherein rotation of the reel winds the tether and pulls the collapsible liquid container toward the reel.

20. The apparatus recited in claim 17, wherein the frame is an adjustable frame comprising:
a first side frame and a second side frame, each of the first and second side frames having a plurality of apertures disposed therein; and,
at least one end frame removably positionable between the first and second side frames at a selected longitudinal position by inserting one or more pins through corresponding apertures in the at least one end frame and the plurality of apertures of the side frames.
